(19) United States
(12) Patent Application Publication
(10) Pub. No.: US 2005/0152688 A1
(43) Pub. Date: Jul. 14, 2005

(54) METHOD FOR RECORDING DVD-R/RW DISCS

(76) Inventors: Chen-Hung Chen, Taipei City (TW); Chien-Chung Lee, Taipei City (TW); Jen-Yi Huang, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/905,337

(22) Filed: Dec. 28, 2004

(30) Foreign Application Priority Data
Jan. 8, 2004 (TW) 093100453

(51) Int. Cl. H04N 5/781

(52) U.S. Cl. 386/125; 386/126

(57) ABSTRACT

A method for recording DVD-R/RW discs uses a recordable DVD player, which supports the DVD-R/RW recording specification, to write the DVD-R/RW discs according to the DVD+VR specification. In this way, the DVD-R/RW discs can be played by players that support the DVD-Video and DVD+VR specifications.

### BACKGROUND OF INVENTION

1. Field of the Invention

The present invention relates to a method for recording DVD-R/RW discs, and more particularly, to a method for recording DVD-R/RW discs according to the DVD+VR specification.

2. Description of the Prior Art

Since DVD optical discs have high memory capacity, an optical disc drive or a disc player can write files of a computer or video data into a rewritable DVD disc.

There are many types of rewritable DVD optical discs in the market such as DVD-RAM discs, DVD-R/RW discs (DVD-R disc and DVD-RW disc), and DVD+R/RW discs (DVD+R disc and DVD+RW disc). However, the recording specifications of these optical discs are not compatible with each other. Therefore, there are recordable DVD optical disc drives, which support multiple types of DVD optical discs, such as a dual optical disc drive for reading and writing both DVD-R/RW discs and DVD+R/RW discs.

Generally, there are two types of DVD players. One is a playing type and the other is a recording/playing type. The playing-type DVD player includes a DVD-ROM optical disc drive combining with related hardware and only plays DVD discs conforming to the DVD-Video specification. The DVD-Video specification is a specification for recording movies or program video data. In other words, the playing-type DVD player only supports discs of the DVD-Video specification.

The recording/playing-type (recordable) DVD player includes a recordable DVD optical disc drive combining with related hardware. If the recordable DVD optical disc drive supports the DVD+R/RW recording specification, the recording/playing-type DVD player only can record DVD+R/RW discs. When recording video data, the recording specification is the DVD+Video recoding (DVD+VR) specification. If the recordable DVD optical disc drive supports the DVD-R/RW recording specification, the recording/playing-type DVD player only can record DVD-R/RW discs. Therefore, when recording video data, the recording specification is the DVD-Video recoding (DVD-VR) specification.

Generally, when a user puts a DVD-R or a DVD-RW disc into a recording/playing-type DVD player, video data cannot be recorded in the DVD-R/RW discs if the recording/playing-type DVD player only supports the DVD+R/RW recording specification. Furthermore, if the recording/playing-type DVD player supports the DVD-R/RW recording specification, the recording/playing-type DVD player will record video data in the DVD-R/RW discs according to the DVD-VR specification.

However, the DVD-VR specification is not compatible to the DVD-Video specification. That is, video data recorded in the DVD-R/RW discs cannot be played by the playing-type DVD player. The DVD-R/RW discs can only be played by the recording/playing-type DVD player, which supports the DVD-R/RW recording specification. Thus, it is very inconvenient to play DVD-VR video data.

### SUMMARY OF INVENTION

It is therefore a primary objective of the claimed invention to provide a method for recording DVD-R/RW discs to solve the above-mentioned problem. The claimed invention records the DVD-R/RW discs according to the DVD+VR specification, such that the DVD-R/RW discs can be played by the playing-type DVD player.

The claimed invention provides a method for recording a DVD-RW disc by using an optical disc drive supporting the DVD-R/RW recording specification to write the DVD-RW disc according to the DVD+VR specification.

First, a specific section within the range from lbn0 to lbn400h of a DVD-RW disc is formatted. Titles are sequentially written after the specific section. After each title is written, a DVD descriptor file of the specific section is updated. Finally, a close session operation is performed to generate a lead-in area and a lead-out area.

The claimed invention further provides a method for recording a DVD-R or a DVD-RW disc by using an optical disc drive supporting the DVD-R/RW recording specification to write the DVD-R disc or the DVD-RW disc according to the DVD+VR specification.

First, a track of a specific section within the range from lbn0 to lbn400h of the DVD-R or the DVD-RW disc is reserved. Titles are sequentially written after the specific section, wherein after each tile is written, a file and system data area and a reserve space allocation table are subsequently written after each title. After all titles and the corresponding file and system data areas and reserve space allocation tables are written, a DVD descriptor file of the specific section is written according to all file and system data areas and reserve space allocation tables. Finally, a close session operation is performed to generate a lead-in area and a lead-out area.

The claimed invention further provides a method for recording a DVD-RW disc by using an optical disc drive supporting the DVD-R/RW recording specification to write the DVD-RW disc according to the DVD+VR specification.

First, the DVD-RW is entirely formatted. Titles are written after a specific section of the range from lbn0 to lbn400h. After each title is written, a DVD descriptor file of the specific section is updated. Finally, a close operation is performed to generate a lead-in area and a lead-out area.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a storage arrangement of a DVD+RW disc in an application layer according to a DVD+VR specification.

FIG. 2 is a flowchart of writing a DVD-RW disc according to the DVD+VR specification.

FIG. 3 shows a storage arrangement of a DVD+R disc according to the DVD+VR specification.

FIG. 4 is a flowchart of writing a DVD-R or a DVD-RW disc according to the DVD+VR specification.

FIG. 5 is a flowchart of writing a DVD-RW disc according to the DVD+VR specification.

### DETAILED DESCRIPTION

In the prior art, the recording/playing-type DVD player, which supports the DVD-R/RW recording specification, is only capable of recording video data of the DVD-VR specification. Therefore, the video data recorded in the DVD-R/RW discs cannot be played by the DVD-Video player. In order to solve this problem, the present invention utilizes a recordable DVD player, which supports the DVD-R/RW recording specification, to write DVD-R/RW discs according to the DVD+VR specification.

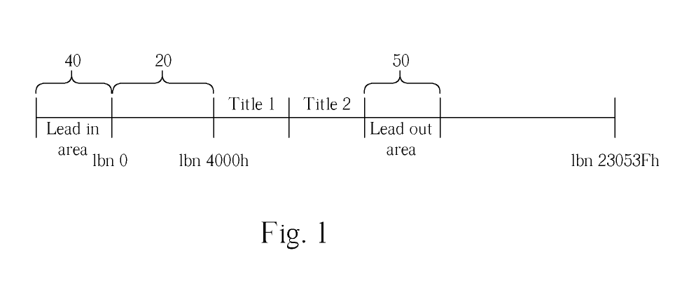

Please refer to FIG. 1, which shows a storage arrangement of a DVD+RW disc in an application layer according to the DVD+VR specification. Generally, according to the DVD+VR specification, the storage arrangement of the DVD+RW disc includes 230540h (hexadecimal) logical blocks and thereby has logical block numbers (lbn) from 0 to 23053Fh.

According to the DVD+VR specification, the storage range between lbn0 and lbn400h is used for storing a DVD descriptor file 20. The DVD descriptor file 20 includes two data files, shown as follows:

$$\begin{matrix}VODEO\_TS: VIDEO\_TS . IFO & ( I ) \\ VIDEO\_TS . VOB & \\ VTS\_ 01 \_ 0. IFO & \\ VTS\_ 02 \_ 0. IFO & \\ VTS\_ 03 \_ 0. IFO & \\ ⋮ & \\ VIDEO\_RM: VIDEO\_RM . IFO & ( II )\end{matrix}$$

The DVD descriptor file 20 is a file system defined by the DVD+VR specification, conforming to universal disc format (UDF) or IS09660 format. The DVD descriptor file 20 stores data size, data location and data format of the DVD+R/RW disc.

Logical blocks after lbn400h are used for storing a plurality of video data sections and each video data section can be treated as a title. According to the DVD+VR specification, there are only 49 titles after lbn400h; that is, 49 video data sections are used for storing video data.

The DVD+RW disc is rewritable and can be repeatedly written and modified. After each title is completely recorded, the DVD descriptor file 20 within the range from lbn0 to lbn400h is updated by the information of each title, such as data size, location, and format.

Take FIG. 1 for example. After the first title (Title 1) is completely recorded, the data size, location, and format recorded in Title 1 are directly stored in the DVD descriptor file 20 in the range from lbn0 to lbn400h. After the second title (Title 2) is completely recorded, the DVD descriptor file 20 is updated again. Therefore, the contents of Title 1 and Title 2 and related information are stored in the updated DVD descriptor file 20. If more video data needs to be recorded, the contents of each title and related information will be stored in the DVD descriptor file 20.

After all titles (for example, Title 1 and Title 2) are completely recorded, a temporary lead-in area 40 is added before lbn0 and a temporary lead-out area 50 is added after the last title (Title 2) so that the DVD+RW disk is completely recorded and conforms to the DVD+VR specification. Due to the compatibility of DVD+VR and DVD-Video specifications, the DVD+RW disc can be played by players, which support the DVD-Video specification.

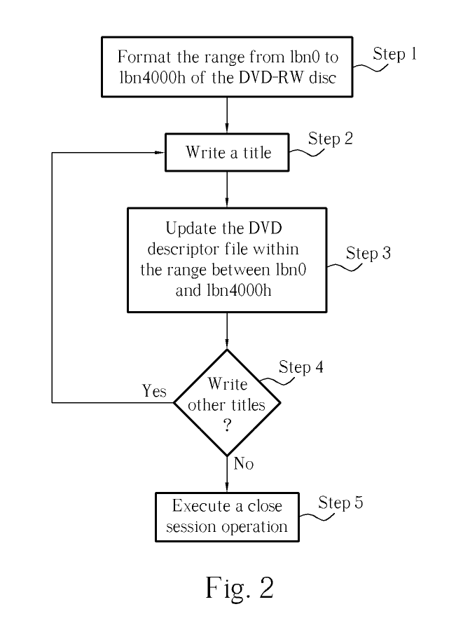

Please refer to FIG. 2, which is a flowchart of writing a DVD-RW disc according to the DVD+VR specification.

Step 1: The range from lbn0 to lbn400h of the DVD-RW disk is formatted.

Step 2: A title is written.

Step 3: The DVD descriptor file 20 within the range between lbn0 and lbn400h is updated.

Step 4: Detect if other titles need to be written. If other titles need to be written, go to step 2. Otherwise, go to step 5.

Step 5: Close session operation is executed.

According to the DVD-R/RW recording specification, the writing operation of the DVD-RW disc is continuous and thereby all sections before the title need to be formatted. After that, the title can be written from the location of lbn400h. In addition, after all titles are written, a close session operation is executed by the DVD-R/RW optical disc drive to generate the lead-in area and the lead-out area. After the above steps are completely executed, the DVD-RW disc conforms to the DVD+VR specification and can be played by DVD players, which support the DVD-Video specification.

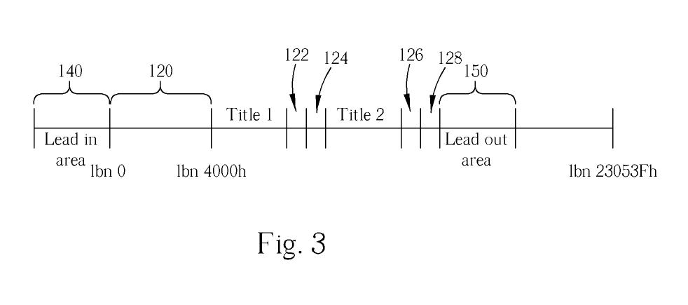

Please refer to FIG. 3, which shows a storage arrangement of a DVD+R disc according to the DVD+VR specification. The DVD+R disc cannot be repeatedly written. Therefore, the DVD descriptor file within the range from lbn0 to lbn400h cannot be written at will. When writing the DVD+R disc according to the DVD+VR specification, a track should be reserved. In other words, a DVD descriptor file 120 between lbn0 and lbn400h is reserved and is not written until all titles are completely recorded. The contents of all titles and related information are written in the DVD descriptor file 120 after all titles are completely recorded.

The DVD+R disc can be written just once. Therefore, the contents of all titles and related information should be written in the DVD descriptor file 120 at the same time after all titles are recorded. When writing the DVD+R disc, a file and system data area and a reserve space allocation table (RSAT) are defined after each title, as shown in FIG. 3.

For instance, after Title 1 is completely recorded, the data size, location and format are recorded in a first file and system data area 122. A first RSAT 124 stores the relation of the first file and system data area 122 and the DVD descriptor file 120. Suppose that there is only one title in the DVD+R disc. This indicates the content of the file and system data area is the same as that of the DVD descriptor file. In this case, the content of the file and system data area is copied in the reserved track of the range from lbn0 to lbn400h to update the DVD descriptor file.

Suppose that there is a plurality of titles in the DVD+R disc, as shown in FIG. 3. Each file and system data area only records a difference to the previous file and system data area. The location difference is recorded in the RSAT. After all titles are recorded, the writing operation of the reserved track in the range from lbn0 to lbn400h is performed according to the contents of all file and system data areas 122 and 126, and RSAT 124 and 128, and the DVD descriptor file 120 is also written.

After all titles are completely recorded, a lead-in area 140 is added before lbn0 and a lead-out area 150 is added after the last title, such that the DVD+R disc conforms to the DVD+VR specification. Due to the compatibility of DVD+VR and DVD-Video specifications, the DVD+R disc can be played by players that support the DVD-Video specification.

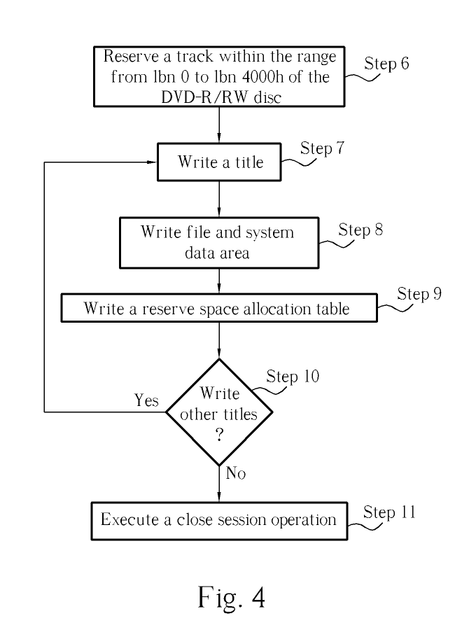

Because a DVD-RW disc can be written by using the method of writing a DVD-R disc, the following method disclosed in FIG. 4 also can be implemented in DVD-RW disc recording.

Please refer to FIG. 4, which is a flowchart of writing a DVD-R or DVD-RW disc according to the DVD+VR specification.

Step 6: In the DVD-R or DVD-RW disk, a track within the range from lbn0 to lbn400h is reserved.

Step 7: A title is written.

Step 8: A file and system data area is written.

Step 9: An RSAT is written.

Step 10: Detect if other titles are to be written. If other titles need to be written, go to step 7. Otherwise, go to step 11.

Step 11: Close session operation is executed.

The writing operation of the DVD-R/RW discs is continuous and thereby all sections before the title need to be reserved. After that, the title can be written from the location of lbn400h. In addition, after all titles are written, a file and system data area and an RSAT are continuously written after each title. After all titles and the corresponding file and system data area and RSAT are written completely, a close session operation is performed on the DVD-R/RW discs to generate the lead-in area and the lead-out area. After the above steps are completely executed, the DVD-R/RW discs conform to the DVD+VR specification and can be played by DVD players that support the DVD-Video specification.

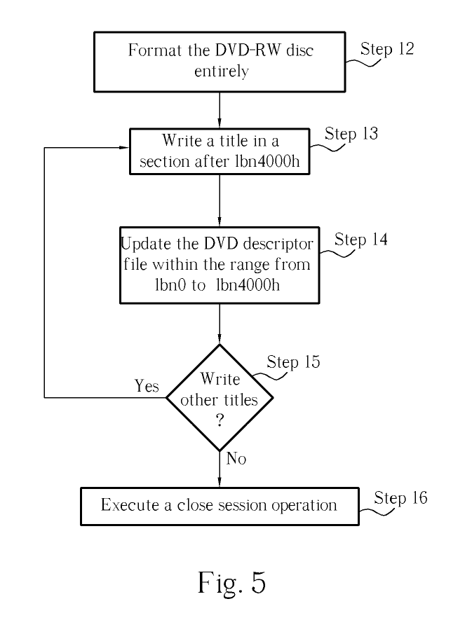

Please refer to FIG. 5, which is a flowchart of writing a DVD-RW disc according to the DVD+VR specification.

Step 12: The DVD-RW disc is entirely formatted.

Step 13: A title is written in a section after lbn400h.

Step 14: The DVD descriptor file within the range of lbn0 and lbn400h is updated.

Step 15: Detect if other titles are to be written. If other titles need to be written, go to step 13. Otherwise, go to step 16.

Step 16: Close session operation is executed.

The DVD-RW disc is entirely formatted before the DVD-RW disc is written. Therefore, writing titles can be discontinuous. Moreover, the DVD descriptor file in the range of lbn0 and lbn400h must be updated after each title is written. After all titles are written, a close session operation is performed by the DVD-R/RW optical disc drive to generate the lead-in area and the lead-out area. After above all steps are completely executed, the DVD-RW disc conforms to the DVD+VR specification and can be played by players that support the DVD-Video specification.

The present invention provides a method for recording DVD-R/RW discs. The advantage of the present invention is that it solves the problem of the recording specification difference between DVD-R/RW and DVD+R/RW discs. The present invention uses the recording/playing-type DVD player, which supports the DVD-R/RW recording specification, to record video data according to the DVD+VR specification.

The present invention further provides a method for recording DVD-R/RW discs. The present invention utilizes a recordable DVD player, which supports the DVD-R/RW recording specification, to record video data according to the DVD+VR specification so that the playing-type player can play such DVD-R/RW discs.

Those skilled in the art will readily observe that numerous modifications and alterations of the device and method may be made while retaining the teachings of the invention. Accordingly, the above disclosure should be construed as limited only by the metes and bounds of the appended claims.

1. A method for recording a DVD-RW disc by using an optical disc drive, which supports a DVD-R/RW recording specification, to write the DVD-RW disc according to a DVD+VR specification, the method comprising:
formatting a section between logical block number 0 and logical block number 4000h of the DVD-RW disc;
sequentially writing at least one title after the section;
updating a DVD descriptor file in the section when the titles are written; and
executing a close session operation after the DVD descriptor file is updated.

2. The method of claim 1 wherein each title is used for storing video data.

3. The method of claim 1 wherein the close session operation is performed to generate a lead-in area and a lead-out area.

4. The method of claim 3 wherein the lead-in area is located before the section and the lead-out area is located after a last title.

5. A method for recording a DVD-R disc or a DVD-RW disc by using an optical disc drive, which supports a DVD-R/RW recording specification, to write the DVD-R disc or the DVD-RW disc according to a DVD+VR specification, the method comprising:
reserving a section between logical block number 0 and logical block number 4000h of the DVD-R disc or the DVD-RW disc;
sequentially writing at least one title after the section, wherein when each title is written, a file and system data area and a reserve space allocation table (RSAT) are subsequently recorded;
writing a DVD descriptor file in the section according to all file and system data areas and reserve space allocation tables when the titles and the corresponding file and system data areas and reserve space allocation tables are written completely; and
executing a close session operation after the DVD descriptor file is updated.

6. The method of claim 5 wherein each title is used for storing video data.

7. The method of claim 5 wherein the close session operation is performed to generate a lead-in area and a lead-out area.

8. The method of claim 7 wherein the lead-in area is located before the section and the lead-out area is located after the reserve space allocation table corresponding to a last title.

9. A method for recording a DVD-RW disc by using an optical disc drive, which supports a DVD-R/RW recording specification, to write the DVD-RW disc according to a DVD+VR specification, the method comprising:
entirely formatting the DVD-RW disc;
writing at least one title after a section of the range from logical block number 0 to logical block number 4000h;
updating a DVD descriptor file of the section when the titles are written; and
executing a close session operation after the DVD descriptor file is updated.

10. The method of claim 9 wherein each title is used for storing video data.

11. The method of claim 9 wherein the close session operation is performed to generate a lead-in area and a lead-out area.

12. The method of claim 11 wherein the lead-in area is located before the section and the lead-out area is located after a last title.
